(19) United States
(12) Patent Application Publication
(10) Pub. No.: US 2005/0150677 A1
(43) Pub. Date: Jul. 14, 2005

(54) Fire protection of openings in fire rated barriers around metallic penetrants and cables using only external rigid seals

(76) Inventors: Adolf R. Hochstim, Pasadena, CA (US); Charles R. Eminhizer, San Diego, CA (US); Donald W. Graumann, Cardiff, CA (US)

Correspondence Address: ADOLF R. HOCHSTIM, 210 N Hudson Ave # 2205, Pasadena, CA, 92110, US

(21) Appl. No.: 11/001,875

(22) Filed: Dec. 2, 2004

Related U.S. Application Data
(60) Provisional application No. 60/527,806, filed on Dec. 6, 2003.

(51) Int. Cl. H01B 7/00

(52) U.S. Cl. 174/65 G

(57) ABSTRACT

A method is invented of sealing through penetrations in fire rated barriers (walls or floors/ceilings), caused by metallic pipes, metallic conduits, metallic cable trays with cables inside, cables, metallic ducts and electric busways, by placing an external firestop seal comprising of cementitious liquid material, which upon curing becomes rigid and heat absorbing. In order to obtain the same fire rating with the same rigid, cementitious fire stop material for an external seal as compared with an internal seal, the total depth of the external seal, on both sides of the fire barrier, was determined to be at most the same as the depth of the internal seal.

### INTRODUCTION

Building officials require fire barriers to be placed throughout the building. Such fire barriers are usually walls and floors rated for 1, 2, 3 or 4 hours, during which no fire, smoke and fumes are to pass across in a fire. The results are based on tests in a standard furnace according to an approved method by building officials. In the USA, the standards are based on American Society of Testing Materials (ASTM) Standard E814-02, equivalent to one in Canada and to International Organization for Standardization (ISO 834), and similar to DIN-4102 in Germany, JISA-1304 in Japan, SISO 24820 in Sweden, etc.

The fire rating F in USA and Canada are approximately equivalent to the integrity rating I in ISO, except that in USA and in Canada a water hose stream test is required, and excess pressures in both furnaces are slightly different, which has no effect on results when firestops are rigid, as in our case.

Once a fire barrier is penetrated by various penetrants like cables, conduits (cables in pipes), pipes, tubing, ducts, cable trays, busways, etc., then the fire barrier is compromised. The created openings (“through penetrations”) are required to be sealed with special fire stop materials, which offer the same fire rating as the fire barrier had before being penetrated as tested by the same above listed standards. An additional property for which the materials are tested and approved is temperature-time rating, so called T ratings in USA and Canada, and resistance R rating under ISO. This rating gives time in hours for which temperature on the off-fire side of a fire barrier is less than 325° F. (181° C.) over ambient temperature, i.e., below the ignition temperature of most common materials.

For metallic penetrants, cables and small plastic pipes the firestops are inserted around penetrants inside the fire barrier. The seals are either insulating, or intumescent (expanding in heat), or heat absorbing, or have combined properties. Heat absorbing involves energy absorption in: (1) phase changes (e.g., sublimation), (2) hydration, breaking bonds between mineral molecule and water (e.g., in CaSO₄.2H₂O), or in (3) chemical reactions.

For plastic pipes, the sealing material consists of intumescent fire retardant wraps around plastic pipes, surrounded by a metallic collar in order to permit only axial expansion toward the center of the plastic pipe, which melts and burns in a fire.

We will address in our invention two new applications in concrete barriers for cables and metallic penetrants, for which until now no one has proposed a solution.

APPLICATION I. The penetration seal deteriorated with age and became non-performing (in the case of fire unable to stop fire, heat, smoke, fumes from propagating through the fire barrier), because either the seal shrank, or became combustible, or with aging lost the intumescence (expansion) property needed to function as a fire seal. This occurred in most old nuclear power plants. When such non-performing seal needs to be removed in order to be replaced with a better firestop seal, it creates problems, like danger of short circuit of touched electric cables, difficulty reaching old seal inside the fire barrier and in nuclear power plants also disposing of old seals which became slightly radioactive.

APPLICATION II. Annular spaces are often built smaller, in error, than required by the approvals based on the fire tests.

In the following we will present our solution to the two applications.

### New Method of External Retrofitting of Penetrations with Heat Absorbing Materials

(For metallic pipes, metallic conduits, metallic tubing, metallic ducts, cables, cables in metallic cable trays, aluminum or steel enclosed electric busways)

For years in nuclear power plants, it was believed that only a fire seal located inside the fire barrier could meet the fire seal requirements and that replacement of internal seals was required if a seal was deemed non-performing. We set out to demonstrate that this is not the case and that a fire seal using the same materials as used for internal seals could when placed external to the fire barrier meet the requirements. To prove this, tests were conducted to determine if a heat absorbing material, like a cementitious mixture of minerals, when placed only on the outside of both sides of the fire barrier, could provide the same fire protection as when the material is placed only inside the fire barrier. The tests were conducted at the Underwriters Laboratories, Inc. (UL®) in USA using a specially designed furnace. The external depth of Flammadur E473 seal on both sides of a floor was chosen in total to be equal to the previously tested systems with the seal inside of the floor (12 inch=305 mm) for steel and copper pipes, and for cables in cable tray. In the tests the external seal extended 4 inch (100 mm) beyond the edge of the penetration opening, sideways. In the test, there was no material placed inside floor, representing the worst situation as if tested with some non performing seal. The results gave the same ratings, which were F=3 hours (for fire, smoke, fumes and seal resistant to water pressure hose stream), equivalent to I rating of ISO without hose stream test, and the temperature-time rating of T=3 hours for cables and T=2 hours for pipes, equivalent to R ratings for ISO. The tests were witnessed by a representative of Factory Mutual Insurance (FM Global), who also approved those systems.

The material used in tests was Flammadur E473, manufactured by AIK Flammadur Brandschutz, GmbH, in the Federal Republic of Germany, and has the following properties:
It is heat absorbing
It is cementitious, containing no asbestos, no halogens
It expands slightly on curing, making a tight fit
It is rigid, resistant to water pressure
It has high thermal conductivity (0.267 Watts/meter ° C.) and thus contributes to a higher rate of heat conduction and thus also to a low ampacity derating.

Flammadur E473 is composed of Portland cement and minerals, which have heat absorbing properties through hydration (e.g. gypsum) plus additives (heat insulating minerals, fire retardant).

FIG. 1, shows penetration through concrete (1) of penetrants (4), which can be metallic pipes, metallic conduits (pipe with cables inside), ducts, busways, cables, etc. They are sealed with an old, non-performing fire seal (2). FIG. 2 shows an example of an installation. Installed is a thin steel sleeve (7), held firmly by an anchor ring (8). One can use a venting opening (9), through which is poured cementitious new seal (3), and which becomes rigid after curing.

FIG. 3 shows a side view cross-section of a cable tray (12) with non-performing seal (2), after the installation of an external rigid seal (3). FIG. 4 shows a top view of the same cable tray, as in FIG. 3. Instead of placing forms around each penetrant, as in FIG. 2, one can use the installation shown in FIG. 5 for multiple penetrants. This involves placing a wall of new rigid seal (3), parallel to concrete wall, here as an example for cable tray (12) with cables (6) inside, pipes (4), and conduits (5). For damming and weight holding of the seal (3), in this installation one can use a metallic shelf (11). One can pour the cementitious seal (3) in horizontal layers, with a temporary damming material placed parallel to the concrete wall.

### LIST OF FIGURES

FIG. 1: View of a penetration with a non-performing fire seal before the installation of an external seal

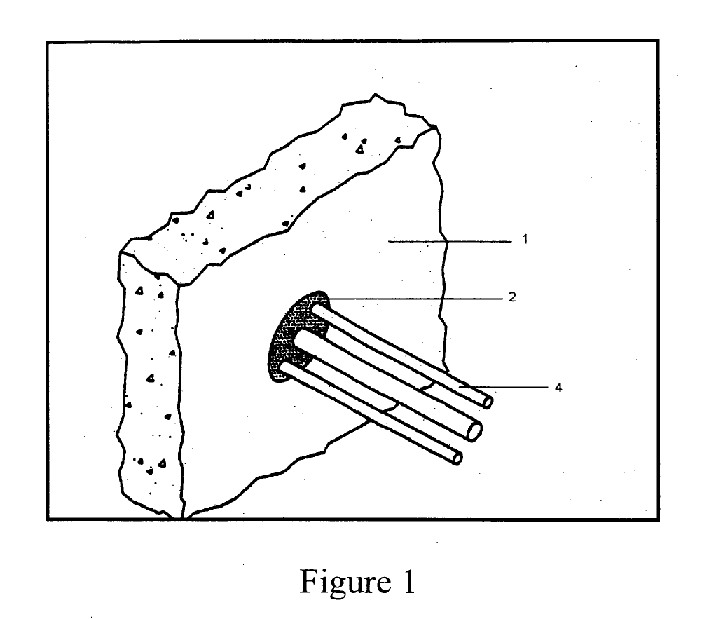

FIG. 2: View of a penetration with a non-performing fire seal after the installation of an external rigid seal

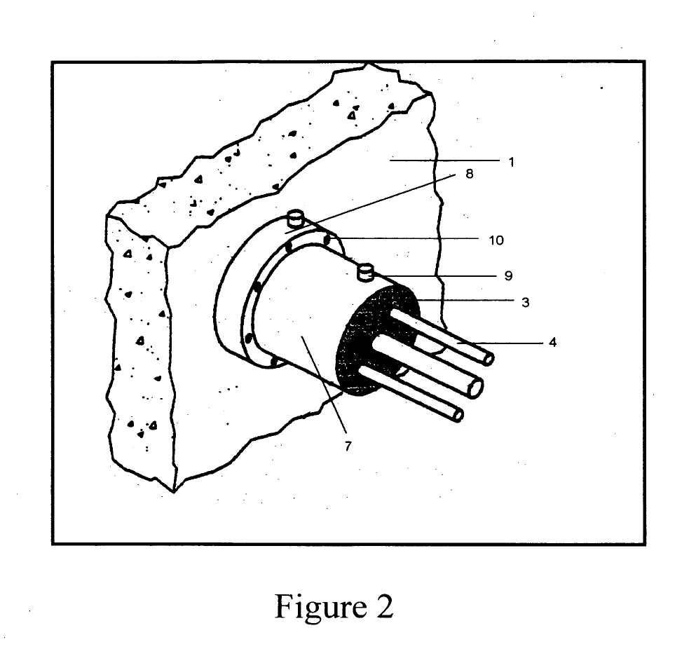

FIG. 3: Side view cross-section of a cable tray with a non-performing fire seal after of the installation of an external fire rigid seal

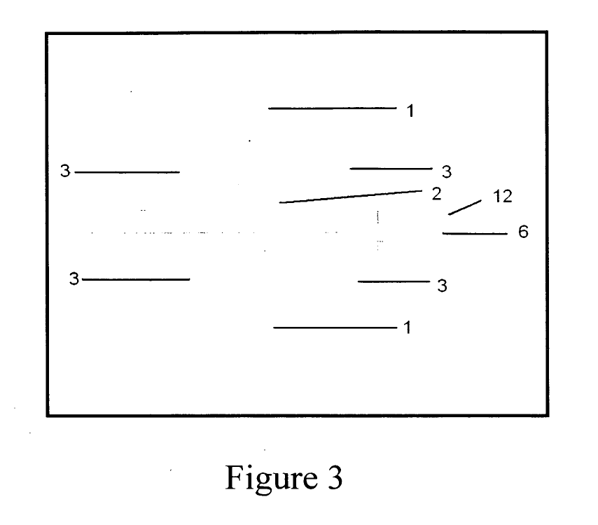

FIG. 4: Top view cross-section of a cable tray with a non-performing fire seal after of the installation of an external fire rigid seal

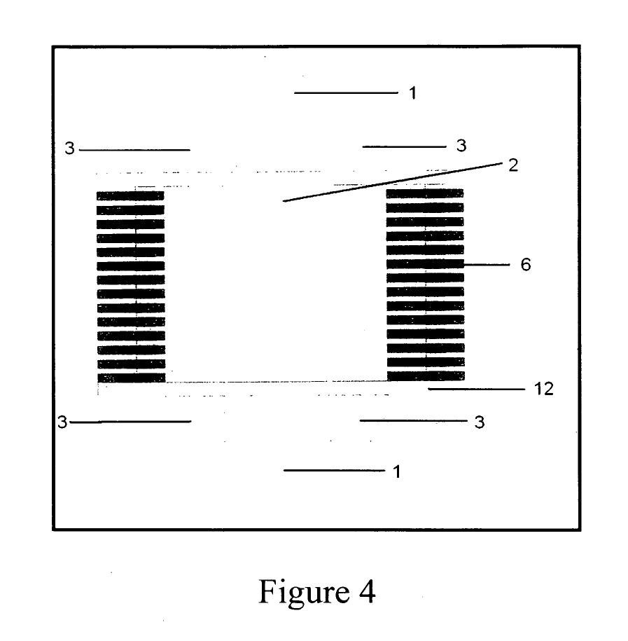

FIG. 5: Side view of a wall with pipes, cables in conduit and cables in cable tray after the installation of an external fire rigid seal for multiple penetrants

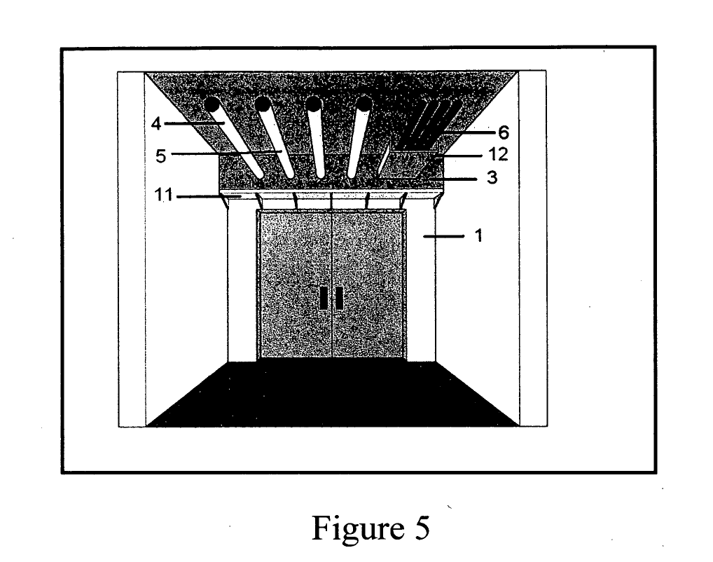

### LIST OF REFERENCE NUMERALS

1—concrete wall or floor
2—old non-performing seal
3—new rigid heat absorbing seal, liquid at start
4—penetrants (metallic pipe, conduit, cable, cable tray, duct, or busway
5—metallic conduit (pipe with cables inside)
6—cable
7—thin steel sleeve
8—anchor ring
9—opening for pouring liquid into the fire seal
10—screws
11—support shelf for 3
12—cable tray

### Appendix I

### Fire Tests and Approvals

Tested at Underwriters Laboratories, Inc. (UL®) and witnessed and approved by Factory Mutual Research (FM Global), for Fire Protection Technologies Inc., (attention Dr. Adolf R. Hochstim and Dr. Charles R. Eminhizer)

UL® System C-AJ-4068,

Factory Mutual Firestop Design System 441 (3 Hours)

| | F (Fire) | T (temperature) |
|---|---|---|
| Type of Cable | Rating (hours) | Rating (hours) |
| 1/C 350 kcmil power cables | 3 | 1 |
| 7/C 12 AWG control cable | 3 | 3 |

UL® System C-AJ-1434,

Factory Mutual Firestop Design System 442 (3 Hours)

| | Maximum Outside | F(Fire) | |
|---|---|---|---|
| | Diameter | Rating | T (time -temperature) |
| Pipe | inch (mm) | (hours) | Rating (hours) |
| steel pipe* | 24(610) | 3 | 0.75 |
| steel pipe | 6.625(168) | 3 | 2 |
| steel conduit | 6.625(168) | 3 | 2 |
| copper pipe | 6.625(168) | 3 | 1 |
| copper tubing | 6.125(156) | 3 | 1 |
| copper pipe | 2.375(60) | 3 | 2 |
| copper tubing | 2.125(54) | 3 | 2 |

*UL System C-AJ-1504

1. Method of fire, gas and water proofing of through penetrations in fire rated walls and floors, comprising of an external rigid mass of fire stop seal, placed between various penetrants, bound by the entrance of the penetration and on the sides by a damming metallic sleeve, metallic plates or by the walls.

2. Method of fire, gas and water proofing of through penetrations in fire rated walls and floors of claim 1, wherein the external mass performs in a fire test, according to American Society of Testing Materials (ASTM), ASTM Standard E 814, “Fire Tests of Through Penetration Firestops”, or according to International Organization of Standardization, ISO 834, or according to similar standards in different countries, with the same fire and time-temperature ratings, as if the penetration would have been sealed with the same material inside of the penetration.

3. Method of fire, gas and water proofing of through penetrations in fire rated walls and floors of claim 1, wherein the external mass is cementitious, consisting of a mixture of one or more mineral powders, which upon mixing with water become rigid in curing.

4. Method of fire, gas and water proofing of through penetrations in fire rated walls and floors, of claim 1, wherein the external mass can be in the form of a cylinder or a box.

5. Method of fire, gas and water proofing of through penetrations in fire rated walls and floors of claim 1, wherein the mass covers one or more of the penetrants in wall or floor, bound by walls or steel plates or steel forms mounted perpendicular to the wall or floor.

6. Method of fire, gas and water proofing of through penetrations in fire rated walls and floors, of claim 1, wherein the cured mass has the property of expansion on curing.

7. Method of fire, gas and water proofing of through penetrations in fire rated walls and floors of claim 1, wherein the mass has the property of high shearing strength to steel and concrete.

8. Method of fire, gas and water proofing of through penetrations in fire rated walls and floors of claim 1, wherein the cured external mass has the property of heat absorption, like-that of hydration, resulting from breaking molecular bonds between water molecules and certain minerals (hydrates).

9. Method of fire, gas and water proofing of through penetrations in fire rated walls and floors of claim 1, wherein the cured external mass has the property of high thermal conductivity which results in a low ampacity derating.

10. Method of fire, gas and water proofing of through penetrations in fire rated walls and floors, of claim 1, wherein the external mass, due to small expansion in curing, has the property of being tight to penetrations by fire, heat, smoke, fumes and water.

11. Method of fire, gas and water proofing of through penetrations in fire rated walls and floors of claim 1, wherein the cured external mass maintains, for the lifetime of the structure, its ability to perform in the fire, with the same fire ratings and fire retarding as originally.

12. Method of fire, gas and water proofing of through penetrations in fire rated walls and floors of claim 1, wherein the fire protection of the external cured mass does not change when exposed to gamma radiation present in nuclear power plants.

13. Method of fire, gas and water proofing of through penetrations in fire rated walls and floors of claim 1, wherein the cured external mass can be held firmly in curing by metallic sleeve and with steel supporting rods, or plates mounted perpendicularly to the wall or floor.

14. Method of fire, gas and water proofing of through penetrations in fire rated walls and floors of claim 1, wherein the penetrants are metallic pipes, metallic conduits with cables inside, metallic ducts, electric metallic tubing (EMT), metal enclosed electric busways, cables and metallic cable trays with cables inside.

15. Method of fire, gas and water proofing of through penetrations in fire rated walls and floors of claim 1, wherein the external cured mass can be any material, which has some of the properties described in claim 3 through claim 11, as long as it passes the fire tests, as described in claim 2.

16. Method of fire, gas and water proofing of through penetrations in fire rated walls and floors of claim 1, wherein the external cured mass which satisfies the properties outlined in claim 2 through 12, can be Flammadur E473, developed by AIK, a division of Allgemeine Elektrizität Geselschaft (AEG)-German General Electric, and is now manufactured by AIK Flammadur Brandschutz, GmbH in Kassel, Federal Republic of Germany.
